(19) United States
(12) Patent Application Publication
(10) Pub. No.: US 2026/0217917 A1
(43) Pub. Date: Jul. 30, 2026

(54) RESIN COMPOSITION AND APPLICATIONS THEREOF

(71) Applicant: DUPONT ELECTRONICS, INC., Wilmington, DE (US)

(72) Inventor: TUNG-LIN LI, HSINCHU CITY (TW)

(21) Appl. No.: 19/445,984

(22) Filed: Jan. 12, 2026

Related U.S. Application Data
(60) Provisional application No. 63/750,517, filed on Jan. 28, 2025.

(51) Int. Cl. C08G 73/10; C08J 5/18; C08K 3/22

(52) U.S. Cl. CPC C08G 73/1071; C08J 5/18; C08K 3/22; C08J 2379/08; C08K 2003/2265; C08K 2003/2272

(57) ABSTRACT

The present disclosure provides a resin composition, a resin film prepared therefrom, and a metal clad laminate comprising the resin film. The resin composition comprises: a base resin component, comprising a dianhydride and a diamine; and a black pigment, comprising oxide of Cr. The resin film prepared form the resin composition may appear black in color and has good dielectric properties.

### FIELD OF THE DISCLOSURE

The present disclosure provides a resin composition, more particularly a resin composition that may provide black appearance and good dielectric properties when formed into a resin film. The present disclosure also provides applications of the resin composition.

### BACKGROUND OF THE DISCLOSURE

Polyimide materials are widely used in electronic fields such as printed circuit boards (PCBs) and integrated circuit substrate (IC substrate) due to their excellent mechanical strength, heat resistance, oxidation resistance, chemical resistance, electrical properties, and the like. In some applications, polyimide films may not only act as insulating layers, but also provide the function of protection or shielding for electronic devices. In these applications, light-shielding properties may be deemed as an important consideration factor.

One of the methods for imparting light-shielding properties is to directly apply a black ink on the surface of a polyimide film. Such methods may involve printing processes such as screen printing or the like. However, the black ink printed in this manner often leads to unevenness on the surface, which may lead to poor workability and low efficiency. In addition, the printed black ink may peel off from the polyimide film, especially when the polyimide undergoes bending. As a result, light-shielding ability is lost and the peeled off black ink may contaminate the electronic device.

Another method for imparting light-shielding properties is to add colorants, such as pigments, dyes and the like into polymer formulations to form dark-colored polyimide films. For examples, carbon black and titanium black have been used to reduce light transmittance and to provide black appearance. However, due to the nature of carbon black and titanium black, when they are used, the dielectric loss (Df) of the polyimide film usually increases. Therefore, there remains a challenge for producing a black polyimide film without sacrificing dielectric properties.

### SUMMARY OF THE DISCLOSURE

In view of the aforementioned technical problems, the present disclosure provides a resin composition which provides black appearance and good dielectric properties. The resin composition can be formed into a resin film and applied in various electronic fields.

Accordingly, an objective of the present disclosure is to provide a resin composition, which comprises:
a base resin component, comprising a dianhydride and a diamine; and
a black pigment, comprising an oxide of Cr.

In an embodiment of the present disclosure, the dianhydride is selected from the group consisting of 3,3′,4,4′-biphenyltetracarboxylic dianhydride (BPDA), 4,4′-oxydiphthalic anhydride (OPDA), pyromellitic dianhydride (PMDA), 3,3′,4,4′-benzophenone tetracarboxylic dianhydride (BTDA), p-phenylene bis(trimellitate) dianhydride (TAHQ), and combinations thereof.

In an embodiment of the present disclosure, the diamine is selected from the group consisting of p-phenylenediamine (PPD), m-phenylenediamine (MPD), o-phenylenediamine (OPD), 4,4′-oxydianiline (ODA), 1,3-bis(4-aminophenoxy)benzene (TPE-R), 1,4-bis(4-aminophenoxy)benzene, dimer diamine (DDA), 2,2′-dimethyl-4,4′-diaminobiphenyl (mTB), 2,2′-bis(trifluoromethyl)benzidine (TFMB), 4-aminobenzoic acid 4-aminophenyl ester (APAB), and combinations thereof.

In an embodiment of the present disclosure, the oxide of Cr is selected from the group consisting of chromium oxide, iron chromium black, copper chromium black, chromium hematite, manganese chromium nickel black, and combinations thereof.

In an embodiment of the present disclosure, the amount of the black pigment ranges from 3-20 parts by weight based on 100 parts by weight of the base resin component.

Another objective of the present disclosure is to provide a resin film, which is prepared from the aforementioned resin composition.

In an embodiment of the present disclosure, the resin film has an L* value in CIELAB color space of 5 to 45.

In an embodiment of the present disclosure, the resin film has a light transmittance at 550 nm of 13% or less.

In an embodiment of the present disclosure, the resin film has a dielectric loss (Df),
wherein when compared with a reference resin film having a reference dielectric loss (Df₀), the dielectric loss (Df) and the reference dielectric loss (Df₀) fulfill the following formula:

(Df−Df₀)/Df₀<15%
wherein the reference resin film is prepared from the resin composition void of black pigment; and
wherein the dielectric loss (Df) and the reference dielectric loss (Df₀) are measured at a frequency of 10 GHz after subjecting the resin film and the reference resin film at a temperature of 23° C. and a relative humidity of 50% for 24 hours.

Another objective of the present disclosure is to provide a metal clad laminate, which comprises the aforementioned resin film and a metal foil.

To render the above objectives, technical features, and advantages of the present disclosure more apparent, the present disclosure will be described in detail with reference to some embodiments hereinafter.

### DETAILED DESCRIPTION OF THE EMBODIMENTS

Hereinafter, some embodiments of the present disclosure will be described in detail. However, the present disclosure may be embodied in various embodiments, and the protection scope of the present disclosure should not be limited to those described in the specification.

As used herein, the expressions “a”, “the”, or the like recited in the specification and in the claims should include both the singular and the plural forms unless stated otherwise.

As used herein, “dianhydride” and “diamine” are intended to include derivatives thereof. They can be in unreacted form (i.e., monomers) or in reacted or partial-reacted form (i.e., oligomers or polymers).

As used herein, “polyimide” generally refers to a reaction product of dianhydride and diamine. This includes “polyamic acid”, which will be converted to imide by imidization.

The resin composition of the present disclosure and applications thereof are described in detail below.

### Resin Composition

In the present disclosure, the resin composition comprises a base resin component and a black pigment as essential components and may further comprises optional components. The components are described in detail below.

### Base Resin Component

The base resin component comprises a dianhydride and a diamine. Dianhydrides and diamines are common materials for synthesizing polyimides. Therefore, the base resin component is capable of forming a polyimide.

The types of the dianhydride and diamine are not particularly limited and can be selected based on the requirements of the targeted applications. For example, the dianhydride and diamine can be selected to enhance dielectric performance, such as reducing dielectric constant (Dk) or reducing dielectric loss (Df).

Examples of the dianhydride include but are not limited to 3,3′,4,4′-biphenyltetracarboxylic dianhydride (BPDA), 4,4′-oxydiphthalic anhydride (OPDA), pyromellitic dianhydride (PMDA), 3,3′,4,4′-benzophenone tetracarboxylic dianhydride (BTDA), and p-phenylene bis(trimellitate) dianhydride (TAHQ). The aforementioned dianhydrides can be used alone or in combination.

Examples of the diamine include but are not limited to p-phenylenediamine (PPD), m-phenylenediamine (MPD), o-phenylenediamine (OPD), 4,4′-oxydianiline (ODA), 1,3-bis(4-aminophenoxy)benzene (TPE-R), 1,4-bis(4-aminophenoxy)benzene, dimer diamine (DDA) (an aliphatic diamine derived from a dimer acid having from 24 to 48 carbons), 2,2′-dimethyl-4,4′-diaminobiphenyl (mTB), 2,2′-bis(trifluoromethyl)benzidine (TFMB), and 4-aminobenzoic acid 4-aminophenyl ester (APAB). The aforementioned diamines can be used alone or in combination.

The molar ratio of the dianhydride to the diamine can range from 0.9:1 to 1:0.9, such as 0.9:1, 0.95:1, 1:1, 1:0.95, or 1:0.9. In an embodiment of the present disclosure, the molar ratio of the dianhydride to the diamine is 1:1.

### Black Pigment

The resin composition comprises a black pigment to provide black appearance, which may in turn provide the function of light-shielding.

The black pigment comprises an oxide of Cr (Chromium). Examples of the oxide of Cr include but are not limited to chromium oxide, iron chromium black, copper chromium black, chromium hematite, and manganese chromium nickel black. The aforementioned oxides of Cr can be used alone or in combination.

It is found that the inclusion of oxide of Cr as black pigment would not drastically raise the dielectric loss (Dk) of the resin film prepared from the resin composition. In some cases, the inclusion of oxide of Cr even results in a lower dielectric loss as compared to a reference resin film prepared from the same resin composition without a black pigment. These findings are surprising and provide great advantage over conventional species of black pigment used in the art such as carbon black and titanium black, which generally lead to an increase in dielectric loss.

The amount of the black pigment provided in the present disclosure can range from 3-20 parts by weight based on 100 parts by weight of the base resin component. For example, based on 100 parts by weight of the base resin component, the amount of the black pigment can be 3 parts by weight, 4 parts by weight, 5 parts by weight, 6 parts by weight, 7 parts by weight, 8 parts by weight, 9 parts by weight, 10 parts by weight, 11 parts by weight, 12 parts by weight, 13 parts by weight, 14 parts by weight, 15 parts by weight, 16 parts by weight, 17 parts by weight, 18 parts by weight, 19 parts by weight, or 20 parts by weight, or within a range between any two of the values described herein. In one embodiment, the amount of the black pigment ranges from 3-15 parts by weight based on 100 parts by weight of the base resin component. In another embodiment, the amount of the black pigment ranges from 3-10 parts by weight based on 100 parts by weight of the base resin component.

In some embodiments, if certain level of blackness (may be expressed by L* value in CIELAB color space or light transmittance) is needed, it would be preferable that the amount of the black pigment is not lower than 5 parts by weight, or is 5-20 parts by weight, based on 100 parts by weight of the base resin component.

### Optional Components

The resin composition may further comprise optional components to adaptively improve the physical properties or chemical properties of the resin film prepared therefrom, or to improve the processibility of the resin composition. Examples of the optional components include but are not limited to solvents and additives such as porous inorganic materials, catalysts (such as imidization catalysts), plasticizers, antioxidants, flame retardants, dispersants, viscosity modifiers, adhesion modifiers, leveling agents, and any known additives used in the field. The aforementioned additives can be used alone or in combination. Hereinafter, solvents and porous inorganic materials will be exemplified.

### [Solvent]

In an embodiment of the present disclosure, the resin composition further comprises a solvent for the ease of handling. The solvent may be used to uniformly dissolve or disperse the components of the resin composition, to lower the viscosity of the resin composition, and/or to allow forming a resin film with a uniform thickness.

The type of the solvent is not particularly limited and can be any inert solvent that can dissolve or disperse the components of the resin composition but does not react with them. Examples of the solvent include but are not limited to aprotic solvents, such as dimethyl sulfoxide (DMSO), N,N-dimethylformamide (DMF), N,N-dimethylacetamide (DMAc), N-methyl-2-pyrrolidone (NMP), and N-vinyl-2-pyrrolidone. The aforementioned solvents can be used alone or in combination. The amount of the solvent is not particularly limited as long as it can sufficiently dissolve or disperse the components of the resin composition.

### [Porous Inorganic Material]

In an embodiment of the present disclosure, the resin composition can further comprise a porous inorganic material as long as it does not essentially affect the technical effects of the resin composition.

Examples of the porous inorganic material include but are not limited to porous silica, porous alumina, porous zirconia, porous boron nitride, porous barium sulfate, and porous calcium phosphate. The aforementioned porous inorganic materials can be used alone or in combination. In an embodiment of the present disclosure, porous silica is used as the porous inorganic material. Based on 100 parts by weight of base resin component, the amount of the porous inorganic material can range from 0-5 parts by weight, such as 0.1 parts by weight, 0.5 parts by weight, 1 parts by weight, 1.5 parts by weight, 2 parts by weight, 2.5 parts by weight, 3 parts by weight, 3.5 parts by weight, 4 parts by weight, 4.5 parts by weight, or 5 parts by weight, or within a range between any two of the values described herein.

### Preparation of Resin Film

The present disclosure also provides a resin film, which is prepared from the aforementioned resin composition. For example, the resin film can be prepared by first mixing a diamine, a dianhydride and a black pigment in a suitable solvent to form a resin composition; subjecting the resin composition to a preliminary reaction; and then casting it on a substrate for drying and further reaction to form the resin film.

In the preparation procedure exemplified above, the diamine, dianhydride and black pigment can be added in a suitable sequence or added portion-wise for the ease of handling (such as in consideration of viscosity). The preliminary reaction can be performed at 10° C. to 30° C. for 15 minutes to 3 hours; the drying can be performed at 120° C. to 250° C. for 5 minutes to 2 hours; and the further reaction can be performed at 300° C. to 400° C. for 30 minutes to 3 hours.

In the preparation procedure exemplified above, the diamine and the dianhydride would react to form polyimide. Therefore, the resulting resin film would comprise a polyimide. In an embodiment of the present disclosure, the polyimide comprised in the resin film can have a weight average molecular weight (Mw) ranging from 8,000 g/mol to 150,000 g/mol, or 10,000 g/mol to 80,000 g/mol, or 20,000 g/mol to 60,000 g/mol. The weight average molecular weight (Mw) can be determined by gel permeation chromatography (GPC) with reference to standard materials such as polystyrene.

After the preparation procedure, the resulting resin film can have a thickness ranging from 1 μm to 100 μm, or 5 μm to 50 μm, or 10 μm to 30 μm. In an embodiment of the present disclosure, a 12-μm thick resin film is formed. In another embodiment of the present disclosure, a 25-μm thick resin film is formed.

Exemplary preparation methods of the resin film are provided in the Example section below.

### Properties of Resin Film

The resin film can have a black appearance and good dielectric properties. The black appearance can be expressed by L* value in CIELAB color space or light transmittance, and the dielectric properties can be expressed by dielectric loss or dielectric constant.

The CIELAB color space uses three parameters, a*, b* and L* to define human color perception. Among them, L* is used to define greyscale, with completely black at 0 and completely white at 100. In an embodiment of the present disclosure, the resin film has an L* value in CIELAB color space of 5 to 45, or 10 to 40, or 15 to 40, or 18 to 39. For example, the L* value of the resin film can be 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40, or within a range between any two of the values described herein.

Another way to evaluate blackness is by light transmittance. In an embodiment of the present disclosure, the resin film may have a light transmittance at 550 nm of 13% or less, or 8% or less, or 5% or less, or 0.2% to 4.5%. For example, a resin film of the present disclosure can have a light transmittance at 550 nm of 0, 0.2%, 0.5%, 0.8%, 1%, 1.2%, 1.5%, 1.8%, 2%, 2.2%, 2.5%, 2.8%, 3%, 3.2%, 3.5%, 3.7%, 4%, 4.2%, 4.5%, 4.8%, 5%, 6%, 7%, 8%, 9%, 10%, 11%, 12%, or 13%, or within a range between any two of the values described herein, as long as it can meet the specific application requirements, especially for optical applications. An exemplary testing method of the light transmittance is provided in the Example section.

In some embodiments, if a defined level of blackness is required for the intended use, it would be preferable that the resin film has an L* value in CIELAB color space of 5 to 45 and a light transmittance at 550 nm of 5% or less.

The resin composition and resin film of the present disclosure not only comprise a black pigment to impart black appearance, but the black pigment also does not drastically impair the dielectric properties of the resin film. To evaluate the effect of the black pigment on the dielectric properties of the resin film, one method is to compare the dielectric loss of the resin film to a reference resin film without a black pigment.

In an embodiment of the present disclosure, the resin film has a dielectric loss (Df), wherein when compared with a reference resin film having a reference dielectric loss (Df₀), the dielectric loss (Df) and the reference dielectric loss (Df₀) fulfill the following formula:

$$( Df - {Df}_{0} ) / {Df}_{0} < 15 \%$$

wherein the reference resin film is prepared from the same resin composition without a black pigment, i.e., the resin composition void of black pigment; and
wherein the dielectric loss (Df) and the reference dielectric loss (Df₀) are measured at a frequency of 10 GHz after subjecting the resin film and the reference resin film at a temperature of 23° C. and a relative humidity of 50% for 24 hours.

In an embodiment of the present disclosure, (Df−Df₀)/Df₀ can be less than 15%, or 12% or less, or 10% or less. A lower value means that the black pigment has a lesser adverse impact on the dielectric loss of the resin film. In some cases, the value of (Df−Df₀)/Df₀ can be a negative value. This means that the black pigment does not even raise the dielectric loss but is rather able to reduce it. When dielectric loss is reduced, the resin film can achieve better signal integrity and thermal stability, leading to higher performance in high-frequency applications and contributing to overall energy savings.

### Applications of Resin Composition and Resin Film

The resin composition and resin film can be applied in various fields. Promising applications of the resin film include using it as an insulating layer in a printed circuit board or an IC substrate, particularly in a flexible substrate.

In an embodiment of the present disclosure, a metal clad laminate comprising the resin film is provided. The metal clad laminate may comprise the resin film and a metal foil on one side or both sides of the resin film. For example, the metal clad laminate may take the form of one resin film and one metal foil laminated together; one resin film sandwiched between two metal foils; or a plurality of resin films and metal foils stacked alternatingly. The metal foil can be a copper foil, such as a rolled and annealed copper foil or an electrodeposited copper foil. The copper foil may have a thickness ranging from 2 μm to 35 μm.

In another embodiment of the present disclosure, a protective film or coverlay comprising the resin film is provided. The protective film or coverlay may comprise the resin film and an adhesive layer on at least one side of the resin film. The adhesive layer can provide adhesion to other materials such as copper. The material of the adhesive layer is not particularly limited and can be any species used in the field.

### EXAMPLES

Hereinafter, some examples are provided to illustrate the present disclosure. These examples are provided for illustrative purpose only and are not intended to limit the scope of the present disclosure.

### Raw Materials

The raw materials used in the Reference Examples, Examples, and Comparative Examples are listed in Table 1 below.

TABLE 1

| Raw material | Manufacturer | Description |
|---|---|---|
| BPDA | Haili Chemical | Dianhydride, 3,3′,4,4′-biphenyltetracarboxylic dianhydride, CAS No.: |
| | | 2420-87-3 |
| OPDA | Haili Chemical | Dianhydride, 4,4′-oxydiphthalic anhydride, CAS No.: 1823-59-2 |
| PMDA | Lonza | Dianhydride, pyromellitic dianhydride, CAS No.: 89-32-7 |
| BTDA | Evonik | Dianhydride, 3,3′,4,4′-benzophenone tetracarboxylic dianhydride, |
| | | CAS No.: 2421-28-5 |
| PPD | Amino | Diamine, p-Phenylenediamine, CAS No.: 106-50-3 |
| ODA | Wakayama | Diamine, 4,4′-oxydianiline, CAS No.: 101-80-4 |
| Priamine1075 | Cargill | Diamine, dimer diamine, an aliphatic diamine derived from dimer |
| | | acid having from 24 to 48 carbons, CAS No.: 68955-56-6 |
| TPE-R | Wakayama | Diamine, 1,3-bis(4-aminophenoxy)benzene, CAS No.: 2479-46-1 |
| Nerox3500 | Orion | Black pigment, carbon black, CAS No.: 1333-86-4 |
| 13M-T | Mitsubishi Materials | Black pigment, titanium black |
| 30C940 | The Sheperd Color | Black pigment, chromium green-black hematite, CAS No.: |
| | Company | 68909-79-5 |
| BK6340 | Asahikasei Kogyo | Black pigment, chromium iron oxide, CAS No.: 12737-27-8 |
| Syloid C805 | Grace | Porous inorganic material, amorphous silica, CAS NO.: 7631-86-9 |
| NMP | Lyondell | Solvent, N-methyl-2-pyrrolidone, CAS NO.: 872-50-4 |

### Testing Method

The testing methods for the resin films prepared in the Reference Examples, Examples, and Comparative Examples are described below.

### [Color Space Inspection]

A sample is prepared by cutting the resin film into a size of 10 cm in length×10 cm in width×12 μm in thickness. The sample is inspected using a chroma meter (CR-300, available from Minolta) and the L* value in CIELAB color space is recorded.

### [Light Transmittance]

A sample is prepared by cutting the resin film into a size of 2 cm in length×4 cm in width×12 μm in thickness. The sample is placed into a spectrophotometer (U-3310, available from Hitachi) with the direction of incident light parallel to the thickness direction of the resin film. The light transmittance of the sample is measured at a slit width of 2 nm, a scan rate of 600 nm/min and a path length of 10 mm over a wavelength range of from 300 nm to 800 nm. The light transmittance at 550 nm is recorded.

### [Dielectric Constant and Dielectric Loss]

A sample is prepared by cutting the resin film into a size of 9 cm in length×9 cm in width. The sample is then prebaked at 135° C. for 60 minutes to remove moisture therein. Subsequently, the sample is placed in a chamber at a temperature of 23° C. and a relative humidity (RH) of 50% for 24 hours. Afterward, the sample is taken out from the chamber and analyzed using a vector network analyzer (VNA) (E5063A, available from Keysight) and a 10 GHz split post dielectric resonator (SPDR), with Teflon sample being used as benchmark. The dielectric constant and dielectric loss are determined and recorded.

### Resin System 1

### Preparation of Resin Composition and Resin Film

### Reference Example RE1

To a 350 mL three-neck flask equipped with a mechanical stirrer, 12.22 g (0.1130 mol) of PPD, 1.94 g (0.0067 mol) of TPE-R and 3.57 g (0.0067 mol) of Priamine1075 were added to 244.0 g of NMP, while the interior of the flask was maintained at 25° C. Subsequently, a 6 wt % NMP solution of PPD (containing 0.82 g (0.0076 mol) of PPD) was gradually added to the flask. Finally, 23.48 g (0.0798 mol) of BPDA, 8.25 g (0.0266 mol) of ODPA, 5.80 g (0.0266 mol) of PMDA and 50 g of NMP were added to the flask to form the resin composition of Reference Example RE1. The adding and mixing processes above were conducted in nitrogen atmosphere.

The resin composition was continuously stirred and underwent preliminary reaction at 25° C. until the viscosity at 25° C. reached 50,000 cps to provide a viscous polyamic acid solution. The viscous polyamic acid solution was casted on a substrate by a doctor blade, and then dried in an oven at 180° C. for 12 minutes to provide a polyamic acid film. Afterward, the polyamic acid film was subjected to further reaction at 350° C. for 1 hour in a nitrogen oven to form the polyimide film of Reference Example RE1. The thickness of the polyimide film is 12 μm.

### Examples E1-E3 and Comparative Examples CE1-CE6

To a 350 mL three-neck flask equipped with a mechanical stirrer, 12.22 g (0.1130 mol) of PPD, 1.94 g (0.0067 mol) of TPE-R and 3.57 g (0.0067 mol) of Priamine1075 were added to 244.0 g of NMP, while the interior of the flask was maintained at 25° C. Subsequently, a 6 wt % NMP solution of PPD (containing 0.82 g (0.0076 mol) of PPD) was gradually added to the flask. Then, according to the components and proportions listed in Table 2, a black pigment was added to the flask with mechanical stirring. Finally, 23.48 g (0.0798 mol) of BPDA, 8.25 g (0.0266 mol) of ODPA, 5.80 g (0.0266 mol) of PMDA and 50 g of NMP were added to the flask to form the resin composition of Examples E1-E3 and Comparative Examples CE1-CE6. The adding and mixing processes above were conducted in nitrogen atmosphere.

The resin composition was continuously stirred and underwent preliminary reaction at 25° C. until the viscosity at 25° C. reached 50,000 cps to provide a viscous polyamic acid solution. The viscous polyamic acid solution was casted on a substrate by a doctor blade, and then dried in an oven at 180° C. for 12 minutes to provide a polyamic acid film. Afterward, the polyamic acid film was subjected to further reaction at 350° C. for 1 hour in a nitrogen oven to form the polyimide film of Examples E1-E3 and Comparative Examples CE1-CE6. The thickness of the polyimide film is 12 μm.

The components used in Reference Example RE1, Examples E1-E3 and Comparative Examples CE1-CE6 are summarized in Table 2 below.

TABLE 2

| | | RE1 | E1 | E2 | E3 | CE1 | CE2 | CE3 | CE4 | CE5 | CE6 |
|---|---|---|---|---|---|---|---|---|---|---|---|
| Dianhydride | BPDA | 60 | 60 | 60 | 60 | 60 | 60 | 60 | 60 | 60 | 60 |
| (parts by mole) | ODPA | 20 | 20 | 20 | 20 | 20 | 20 | 20 | 20 | 20 | 20 |
| | PMDA | 20 | 20 | 20 | 20 | 20 | 20 | 20 | 20 | 20 | 20 |
| | BTDA | | | | | | | | | | |
| Diamine | PPD | 90 | 90 | 90 | 90 | 90 | 90 | 90 | 90 | 90 | 90 |
| (parts by mole) | ODA | | | | | | | | | | |
| | Priamine1075 | 5 | 5 | 5 | 5 | 5 | 5 | 5 | 5 | 5 | 5 |
| | TPE-R | 5 | 5 | 5 | 5 | 5 | 5 | 5 | 5 | 5 | 5 |
| Base resin component | | 100 | 100 | 100 | 100 | 100 | 100 | 100 | 100 | 100 | 100 |
| (parts by weight) | | | | | | | | | | | |
| Black pigment | Nerox3500 | | | | | 2 | 4 | 5 | | | |
| (parts by | 13M-T | | | | | | | | 3 | 5 | 8 |
| weight) | 30C940 | | 3 | 8 | | | | | | | |
| | BK6340 | | | | 8 | | | | | | |
| Porous | Syloid C805 | | | | | | | | | | |
| inorganic | | | | | | | | | | | |
| material | | | | | | | | | | | |
| (parts by | | | | | | | | | | | |
| weight) | | | | | | | | | | | |

### Evaluation of Resin Film

The resin films of Reference Example RE1, Examples E1-E3 and Comparative Examples CE1-CE6 were tested according to the methods described in previous section. In addition, the dielectric loss Df of Examples E1-E3 and Comparative Examples CE1-CE6 were compared with the reference dielectric loss Df₀ of Reference Example RE1. The results are shown in Table 3.

TABLE 3

| | RE1 | E1 | E2 | E3 | CE1 | CE2 | CE3 | CE4 | CE5 | CE6 |
|---|---|---|---|---|---|---|---|---|---|---|
| L* | 41 | 40 | 34 | 36 | 35 | 32 | 31 | 32 | 32 | 31 |
| Transmittance at | 30.8 | 12.8 | 3.7 | 3.1 | 14.7 | 4.9 | 4.6 | 11.7 | 4.9 | 2.2 |
| 550 nm (%) | | | | | | | | | | |
| Dielectric constant | 3.46 | 3.39 | 3.74 | 3.65 | 3.90 | 4.32 | 4.33 | 3.81 | 3.90 | 4.35 |
| Dielectric loss | 0.0047 | 0.0029 | 0.0045 | 0.0043 | 0.0155 | 0.0320 | 0.0153 | 0.0067 | 0.0076 | 0.0114 |
| (Df − Df₀)/Df₀ | | −38% | −4% | −9% | 230% | 581% | 226% | 43% | 62% | 143% |

As shown in Table 3, the resin films of Examples E1-E3 have good dielectric properties especially in term of dielectric loss. This shows that the oxide of Cr used as black pigment can provide blackness while not sacrificing dielectric properties. In some examples, superior performance in dielectric properties can be surprisingly attained. In contrast, conventional black pigments such as carbon black (Comparative Examples CE1-CE3) and titanium black (Comparative Examples CE4-CE6) would lead to a significant increase in dielectric loss and dielectric constant.

### Resin System 2

### Preparation of Resin Composition and Resin Film

### Reference Example RE2

The resin composition of Reference Example RE2 was prepared similarly as in Reference Example RE1, except that the dianhydride and diamine were replaced by the components listed in Table 4. Afterward, the resin composition was made into a resin film in the same manner as in Reference Example RE1 to provide the resin film of Reference Example RE2. The thickness of the resin film is 12 μm.

### Examples E4-E6 and Comparative Examples CE7-CE10

Each of the resin compositions of Examples E4-E6 and Comparative Examples CE7-CE10 was prepared similarly as in Reference Example RE2, except that a black pigment and a porous inorganic material were added according to the components and proportions shown in Table 4. Afterward, the resin composition was made into a resin film in the same manner as in Reference Example RE2 to provide the resin film of Examples E4-E6 and Comparative Examples CE7-CE10. The thickness of the resin film is 12 μm.

The components used in Reference Example RE2, Examples E4-E6 and Comparative Examples CE7-CE10 are summarized in Table 4 below.

TABLE 4

| | | RE2 | E4 | E5 | E6 | CE7 | CE8 | CE9 | CE10 |
|---|---|---|---|---|---|---|---|---|---|
| Dianhydride | BPDA | 82 | 82 | 82 | 82 | 82 | 82 | 82 | 82 |
| (parts by mole) | ODPA | | | | | | | | |
| | PMDA | | | | | | | | |
| | BTDA | 18 | 18 | 18 | 18 | 18 | 18 | 18 | 18 |
| Diamine | PPD | 70 | 70 | 70 | 70 | 70 | 70 | 70 | 70 |
| (parts by mole) | ODA | 30 | 30 | 30 | 30 | 30 | 30 | 30 | 30 |
| | Priamine1075 | | | | | | | | |
| | TPE-R | | | | | | | | |
| Base resin component | | 100 | 100 | 100 | 100 | 100 | 100 | 100 | 100 |
| (parts by weight) | | | | | | | | | |
| Black pigment | Nerox3500 | | | | | 2 | 5 | | |
| (parts by weight) | 13M-T | | | | | | | 3 | 8 |
| | 30C940 | | 3 | 8 | | | | | |
| | BK6340 | | | | 8 | | | | |
| Porous inorganic | Syloid C805 | | 2 | 2 | 2 | 2 | 2 | 2 | 2 |
| material | | | | | | | | | |
| (parts by weight) | | | | | | | | | |

### Evaluation of Resin Film

The resin films of Reference Example RE2, Examples E4-E6 and Comparative Examples CE7-CE10 were tested according to the methods described in previous section. In addition, the dielectric loss Df of Examples E4-E6 and Comparative Examples CE7-CE10 were compared with the reference dielectric loss Df₀ of Reference Example RE2. The results are shown in Table 5.

TABLE 5

| | RE2 | E4 | E5 | E6 | CE7 | CE8 | CE9 | CE10 |
|---|---|---|---|---|---|---|---|---|
| L* | 38 | 38 | 35 | 24 | 36 | 29 | 33 | 31 |
| Transmittance at 550 nm (%) | 20.4 | 10.1 | 3.9 | 1.1 | 1.6 | 0 | 2.3 | 0.2 |
| Dielectric constant | 3.54 | 3.48 | 3.56 | 3.63 | 3.83 | 4.19 | 3.71 | 4.11 |
| Dielectric loss | 0.0096 | 0.0086 | 0.0093 | 0.0105 | 0.0142 | 0.0249 | 0.0110 | 0.0153 |
| (Df − Df₀)/Df₀ | | −10% | −3% | 9% | 48% | 159% | 15% | 59% |

As shown in Table 5, similar to the results in resin system 1, the resin films with oxide of Cr (Examples E4-E6) would not drastically raise the dielectric loss, while the ones with carbon black (Comparative Examples CE7-CE8) and titanium black (Comparative Examples CE9-CE10) would. Therefore, conclusion may be drawn that the oxide of Cr can be applied to various resin systems and provides blackness while maintaining good dielectric properties. Moreover, enhanced dielectric properties may be offered compared with the performance of Reference Example.

While some embodiments are provided in the specification, they are only illustrative of the present disclosure and are not intended to limit the protection scope of the present disclosure. Persons skilled in the art may proceed with a variety of modifications based on the disclosure as described without departing from the principle thereof. The protection scope of the present disclosure is as defined in the following claims.

What is claimed is:

1. A resin composition, which comprises:
a base resin component, comprising a dianhydride and a diamine; and
a black pigment, comprising an oxide of Cr.

2. The resin composition of claim 1, wherein the dianhydride is selected from the group consisting of 3,3′,4,4′-biphenyltetracarboxylic dianhydride (BPDA), 4,4′-oxydiphthalic anhydride (OPDA), pyromellitic dianhydride (PMDA), 3,3′,4,4′-benzophenone tetracarboxylic dianhydride (BTDA), p-phenylene bis(trimellitate) dianhydride (TAHQ), and combinations thereof.

3. The resin composition of claim 1, wherein the diamine is selected from the group consisting of p-phenylenediamine (PPD), m-phenylenediamine (MPD), o-phenylenediamine (OPD), 4,4′-oxydianiline (ODA), 1,3-bis(4-aminophenoxy)benzene (TPE-R), 1,4-bis(4-aminophenoxy)benzene, dimer diamine (DDA), 2,2′-dimethyl-4,4′-diaminobiphenyl (mTB), 2,2′-bis(trifluoromethyl)benzidine (TFMB), 4-aminobenzoic acid 4-aminophenyl ester (APAB), and combinations thereof.

4. The resin composition of claim 1, wherein the oxide of Cr is selected from the group consisting of chromium oxide, iron chromium black, copper chromium black, chromium hematite, manganese chromium nickel black, and combinations thereof.

5. The resin composition of claim 1, wherein the amount of the black pigment ranges from 3-20 parts by weight based on 100 parts by weight of the base resin component.

6. A resin film, which is prepared from the resin composition of claim 1.

7. The resin film of claim 6, having an L* value in CIELAB color space of 5 to 45.

8. The resin film of claim 6, having a light transmittance at 550 nm of 13% or less.

9. The resin film of claim 6, having a dielectric loss (Df),
wherein when compared with a reference resin film having a reference dielectric loss (Df₀), the dielectric loss (Df) and the reference dielectric loss (Df₀) fulfill the following formula:
$$( Df - {Df}_{0} ) / {Df}_{0} < 15 \%$$
wherein the reference resin film is prepared from the resin composition void of black pigment; and
wherein the dielectric loss (Df) and the reference dielectric loss (Df₀) are measured at a frequency of 10 GHz after subjecting the resin film and the reference resin film at a temperature of 23° C. and a relative humidity of 50% for 24 hours.

10. A metal clad laminate, which comprises the resin film of claim 6 and a metal foil.
